(19) United States
(12) Patent Application Publication
(10) Pub. No.: US 2012/0043316 A1
(43) Pub. Date: Feb. 23, 2012

(54) HIGH-FREQUENCY HEATING EQUIPMENT

(75) Inventors: Kazuhiro Kawai, Osaka (JP); Kouji Kanzaki, Nara (JP); Hisahiro Nishitani, Nara (JP)

(73) Assignee: PANASONIC CORPORATION, Kadoma-shi, Osaka (JP)

(21) Appl. No.: 13/201,176

(22) PCT Filed: Mar. 3, 2010
(86) PCT No.: PCT/JP2010/001437

§ 371 Date: Aug. 11, 2011

(30) Foreign Application Priority Data
Mar. 3, 2009 (JP) 2009048782

(51) Int. Cl. H05B 6/64; H05B 6/68

(52) U.S. Cl. 219/702

(57) ABSTRACT

A high-frequency heating equipment includes temperature sensor (21) that is mounted with mounting bracket (22) such that temperature sensor (21) can be pressed by a lateral face of cooling fins and an end of temperature sensor (21) points to an anode of magnetron (3). This structure allows positively preventing magnetron (3) from falling into a thermal runaway which invites a breakdown of magnetron (3), and allows determining in a reliable manner whether the operation is a no-load running or a light-load running. The high-frequency heating equipment thus achieves stable performance.

### TECHNICAL FIELD

The present invention relates to a high-frequency heating equipment that can sense fast a temperature of a magnetron and halt operation of the high-frequency heating equipment in a case of no load running, i.e. no object to be heated exists in a heating chamber of the high-frequency heating equipment.

### BACKGROUND ART

A conventional high-frequency heating equipment includes multiple cooling fins provided to a magnetron, and a temperature sensor is mounted to an outside cooling fin of the multiple cooling fins. This conventional example is disclosed in, e.g. Patent Literature 1, and is described hereinafter with reference to FIG. 11-FIG. 13.

High-frequency heating equipment 1 has heating chamber 2, and magnetron 3 oscillates electromagnetic waves, thereby heating object to be heated 5 placed on tray 4 in heating chamber 2.

High-frequency heating equipment 1 comprises the following structural elements:
power supply 6 that supplies a high voltage to magnetron 3 for driving magnetron 3;
cooling fan 7 for cooling magnetron 3 and power supply 6;
controller 8 for transmitting electric signals to magnetron 3 and power supply 6; and
air guide 9 mounted to magnetron 3 for introducing airflow generated by cooling fan 7 into heating chamber 2.

Multiple cooling fins 3B are provided to magnetron 3. Temperature sensor 10 is mounted to outside cooling fin 3C of multiple cooling fins 3B. The temperature sensed by temperature sensor 10 is transmitted to controller 8, and when temperature sensor 10 senses a temperature not lower than a threshold temperature, controller 8 stops the operation of high-frequency heating equipment 1.

The foregoing structure allows the conventional high-frequency heating equipment to work in a regular way, namely, a user puts object to be heated 5 on tray 4 in heating chamber 2, and inputs a heating method and other conditions through operating section 8, and then starts heating. This operation prompts power supply 6 to supply a high voltage to magnetron 3, thereby supplying electromagnetic waves into heating chamber 2 for heating object to be heated 5.

Motor 11 starts rotating at the same time when power supply 6 starts supplying the high voltage to magnetron 3, and cooling fan 7 mounted on the shaft of motor 11 thus generates airflow to cool magnetron 3 and power supply 6. Temperature sensor 10 senses a temperature of cooling fins 3B of magnetron 3. However, most of the electromagnetic waves are absorbed into object to be heated 5 in heating chamber 2, and only a little amount of the electromagnetic waves are reflected to anode 3A of magnetron 3. The temperature of magnetron 3 thus stays lower than a given temperature, and the heating is kept going.

Starting the heat without object to be heated 5 in heating chamber 2 allows most of the electromagnetic waves to reflect and return to magnetron 3, so that anode 3A of magnetron 3 is heated, and this heat travels to cooling fins 3B, thereby raising a temperature of temperature sensor 10. When the temperature of temperature sensor 10 reaches a given temperature, controller 8 cuts off power supply 6. Magnetron 3 thus halts its oscillation, so that an abnormality, e.g. thermal runaway or thermal deformation in resin components can be prevented.

Another conventional high-frequency heating equipment uses a temperature sensor that senses an ambient temperature of a magnetron (high frequency generator), and a sensed signal is transmitted to a controller. This example is disclosed in, e.g. Patent Literature 2, and is described hereinafter with reference to FIG. 14.

High-frequency heating equipment 12 comprises the following structural elements: heating chamber 13 for accommodating an object to be heated, magnetron 3 for supplying electromagnetic waves into heating chamber 13, power supply 14 for driving magnetron 3, cooling fan 15 for cooling magnetron 3 and power supply 14, temperature sensor 16 for sensing an ambient temperature of magnetron 3, and a controller (not shown) for controlling electric components with a sensed signal supplied from temperature sensor 16.

The foregoing structure allows temperature sensor 16 to sense the ambient temperature of magnetron 3 during a no-load running, i.e. no object to be heated existing in heating chamber 13. When the ambient temperature of magnetron 3 exceeds a given temperature, magnetron 3 halts its oscillation or lowers its output, so that an abnormality, e.g. a breakdown of magnetron 3 due to a thermal runaway or a thermal deformation in resin components, can be prevented.

Conventional high-frequency heating equipment 1 disclosed in Patent Literature 1; however, has the following problem: If the heating starts with no object to be heated 5 in heating chamber 2, most of the electromagnetic waves traveling into chamber 2 reflects and returns to magnetron 3, so that anode 3A of magnetron 3 is heated and the temperature rise of anode 3A is conveyed to ambient subjects by means of, e.g. the heat conduction to cooling fins 3B, the heat radiation from the surface of anode 3A, the heat convection from the surface of anode 3A and the surface of cooling fins 3B. The temperature of temperature sensor 10 mounted to outside cooling fin 3C of magnetron 3 rises only due to the heat convection.

A temperature rise during the no-load state or a temperature rise during a light-load state, e.g. a slice of bacon or some pop-corns, should be determined with a ratio of a quantity of heat produced by the heat convection vs. the total quantity of heat produced by the heat convection, heat conduction and heat radiation. However, the temperature rise per se disperses because there are dispersion factors such as dispersion in the mounting state of temperature sensor 10, deformation of cooling fins 3B, and dispersion in the rpm of cooling fan 7. It can be thus concluded that it is very difficult to accurately detect and control the no-load state based on a small difference in temperatures.

If the temperature rise of magnetron 3 cannot be sensed accurately, magnetron 3 encounters a thermal runaway and breaks down, or resin components, e.g. air guide 9, are deformed. Broken-down magnetron 3 thus needs to be replaced with a new one, so that this high-frequency heating equipment has a disadvantage in view of resource saving.

On top of that, since temperature sensor 10 is placed outside cooling fins 3B, it is subjected to the airflow supplied from cooling fan 7 or the room temperature. Temperature sensor 10 thus tends to malfunction. For instance, anode 3A of magnetron 3 stays at a high temperature during the no-load running even if the room temperature stands at 0(zero)° C. However, outside cooling fin 3C is cooled by the airflow at 0(zero)° C. supplied from cooling fan 7, so that a detection of the temperature rise is delayed, and magnetron 3 falls in danger of breaking down.

On the other hand, the temperature of temperature sensor 10 rises faster when the room temperature stands at as high as 30° C., and a halting signal is transmitted to controller 8. As a result, even in a light-load running, magnetron 3 stops its oscillation and a cooking might be halted halfway.

High-frequency heating equipment 12 disclosed in Patent Literature 2 is formed of temperature sensor 16 that senses an ambient temperature of magnet 3 and a controller that controls electric components with a sensed signal supplied from temperature sensor 16. Temperature sensor 16 determines whether a temperature rise is caused by a no-load running or a light-load running based on a ratio of a quantity of heat produced by the heat convection vs. the total quantity of heat produced by the heat convection, conduction and radiation. However, a mounting state of temperature sensor 16, deformation of cooling fan 15, and dispersion of the rpm of cooling fan 15 cause dispersion of the temperature rise of temperature sensor 16. It can be thus concluded that it is very difficult to accurately detect and control the no-load state based on a small difference in temperatures.

Conventional high-frequency heating equipment 12 employs bulky temperature sensor 16 which occupies a rather large area, so that temperature sensor 16 senses a temperature rise with a time delay from an actual temperature rise of anode 3A of magnetron 3. The follow-up action of temperature sensor 16 thus becomes insubstantial due to dispersion in performance of magnetron 3 or when magnetron 3 encounters a sharp temperature rise caused by an inadequate matching between heating chamber 13 and magnetron 3. The foregoing factors might induce a thermal runaway of magnetron 3, which then breaks down, or invite melt-down of resin components near magnetron 3.
1. Unexamined Japanese Patent Application Publication No. 2002-260841
2. Unexamined Japanese Patent Application Publication No. 2004-265819

### DISCLOSURE OF INVENTION

The present invention determines accurately whether a temperature of a magnetron is raised by a no-load running in a heating chamber or a light-load running, e.g. a slice of bacon or popcorn in the heating chamber, and reduces a risk of break down of the magnetron due to the temperature rise or a risk of melt-down of resin components. In other words, a malfunction, such as a light-load running is erroneously determined as a no-load running, and thereby halting a cooking operation halfway, can be prevented. The present invention thus can provide a high-frequency heating equipment that can be handled by a user with more ease and more safety and has an advantage in view of resource saving.

The high-frequency heating equipment of the present invention comprises the following structural elements:
a heating chamber for accommodating an object to be heated;
a magnetron including multiple cooling fins and radiating electromagnetic waves into the heating chamber;
a power supply for driving the magnetron;
   a cooling fan for cooling the magnetron and the power supply;
a temperature sensor for sensing a temperature of the magnetron;
a mounting bracket holding the temperature sensor;
an air guide for guiding an airflow supplied by the cooling fan; and
a controller for controlling the power supply, the magnetron, and the cooling fan.

The temperature sensor is mounted with the mounting bracket such that the temperature sensor is pressed by a lateral face of the cooling fins, and an end of the temperature sensor points to an anode of the magnetron on the downwind side of the cooling fan.

The structure discussed above allows the temperature sensor to sense a temperature close to the temperature of the anode of the magnetron, so that dispersing factors, e.g. a mounting state of the mounting bracket, deformation of the cooling fan, and dispersion in the rpm of the cooling fan, are excluded from causing the temperature sensor to delay sensing a temperature rise. As a result, a risk of thermal runaway which may break down the magnetron as well as a risk of melt-down of the resin components near the magnetron can be reduced. Replacements of the broken-down magnetron or melt-down components with new ones can be thus reduced, so that the high-frequency heating equipment of the present invention is advantageous in view of resource saving.

### BRIEF DESCRIPTION OF THE DRAWINGS

FIG. 1 is a sectional view of a high-frequency heating equipment in accordance with a first embodiment of the present invention.

FIG. 2 is a plan view of an essential part of the high-frequency heating equipment in accordance with the first embodiment.

FIG. 3 is a front view of an essential part of the high-frequency heating equipment in accordance with the first embodiment.

FIG. 4 is a plan view of a temperature sensor in accordance with the first embodiment.

FIG. 5 is a front view of a temperature sensor in accordance with the first embodiment.

FIG. 6A shows variations in temperature during a no-load running in accordance with the first embodiment.

FIG. 6B is a graph of the variations in temperature during the no-load running.

FIG. 7A shows variations in temperature during a light-load running in accordance with the first embodiment.

FIG. 7B is a graph of the variations in temperature during the light-load running.

FIG. 8A shows differences in temperature between the no-load running and the light-load running in accordance with a first embodiment of the present invention.

FIG. 8B is a graph of the differences in temperature between the no-load running and the light-load running.

FIG. 9 is a lateral view cutaway in part of a mounting bracket in accordance with a second embodiment of the present invention.

FIG. 10 is a lateral view of a mounting bracket in accordance with a third embodiment of the present invention.

FIG. 11 is a lateral view illustrating a structure of a conventional high-frequency heating equipment.

FIG. 12 is a plan view illustrating an essential part of the conventional high-frequency heating equipment.

FIG. 13 is a front view illustrating an essential part of another conventional high-frequency heating equipment.

FIG. 14 is a lateral view illustrating a structure of the another conventional high-frequency heating equipment.

### DETAILED DESCRIPTION OF THE PREFERRED EMBODIMENTS

Exemplary embodiments of the present invention are demonstrated hereinafter with reference to the accompanying drawings. The present invention is not limited to these embodiments.

### Exemplary Embodiment 1

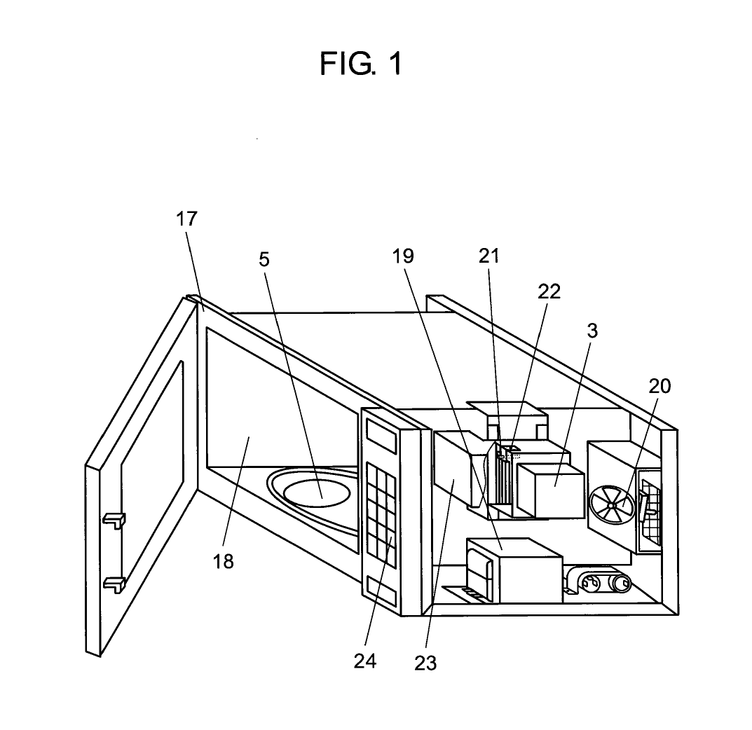

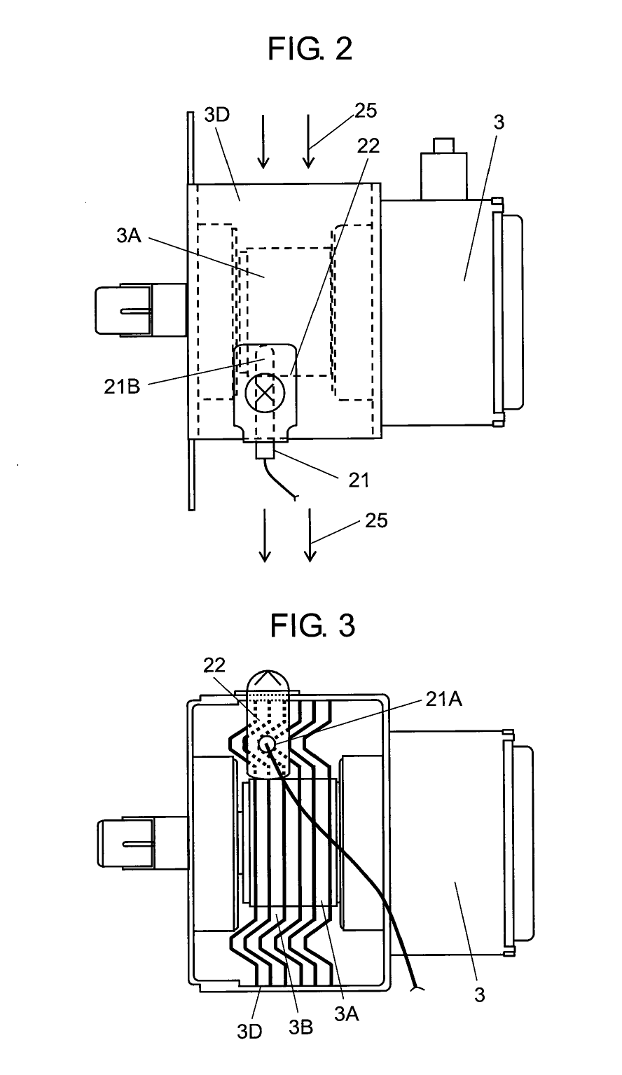

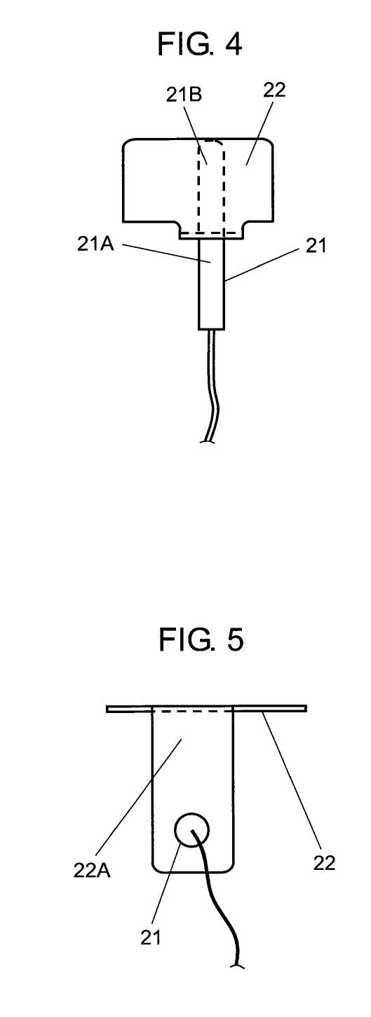

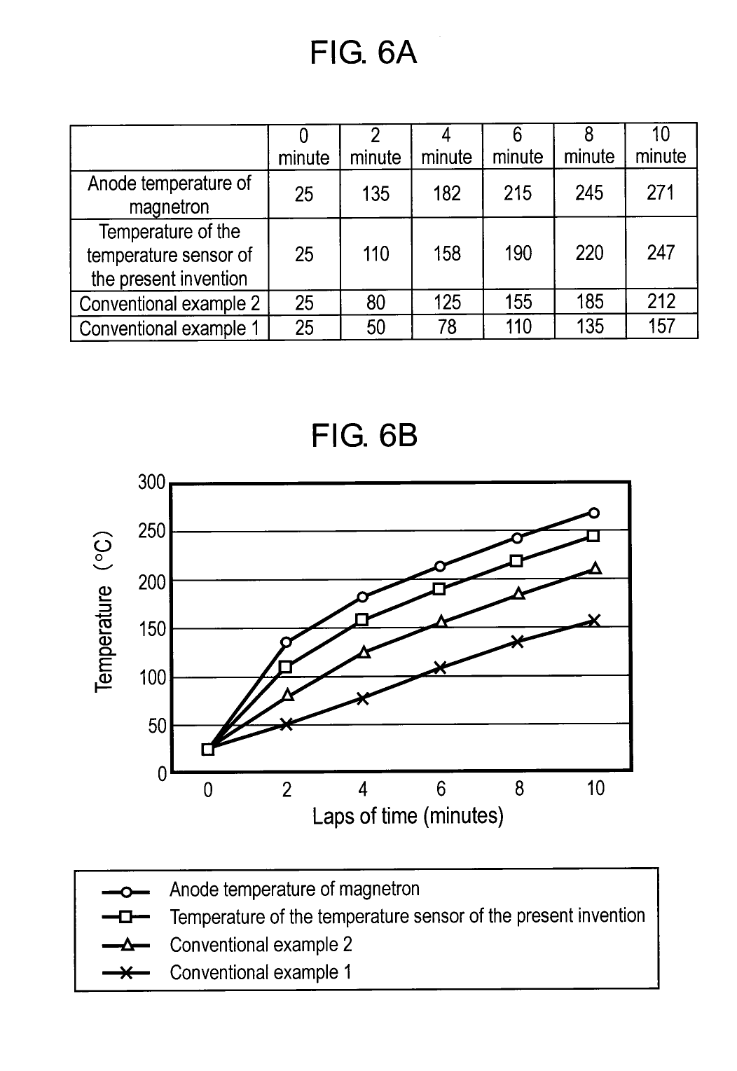

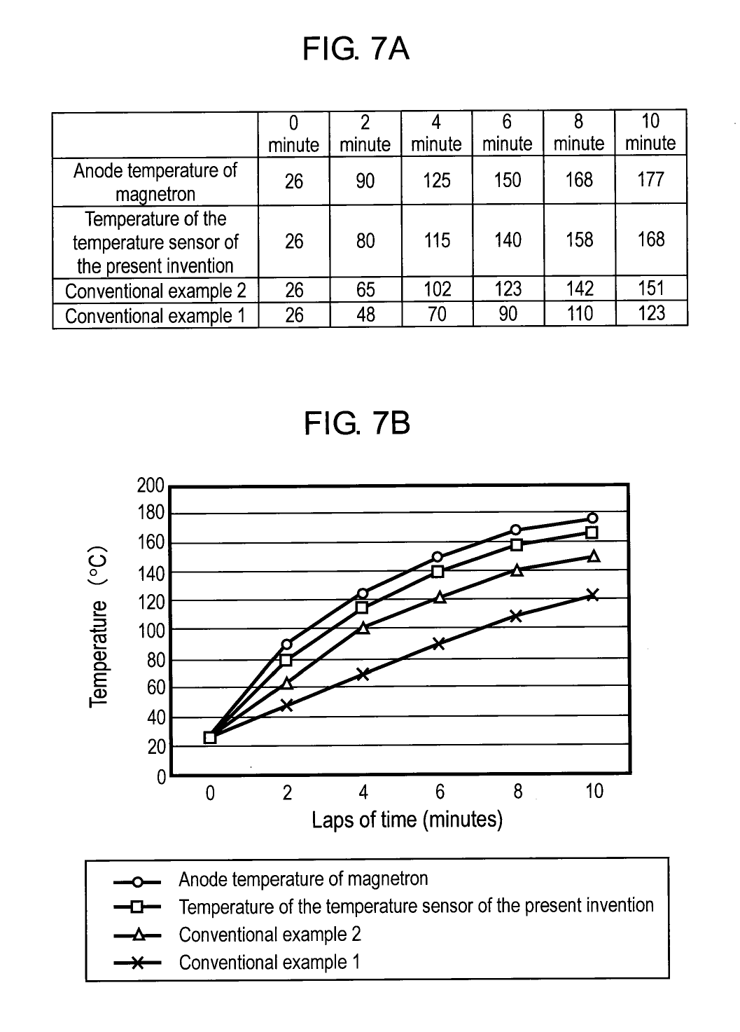

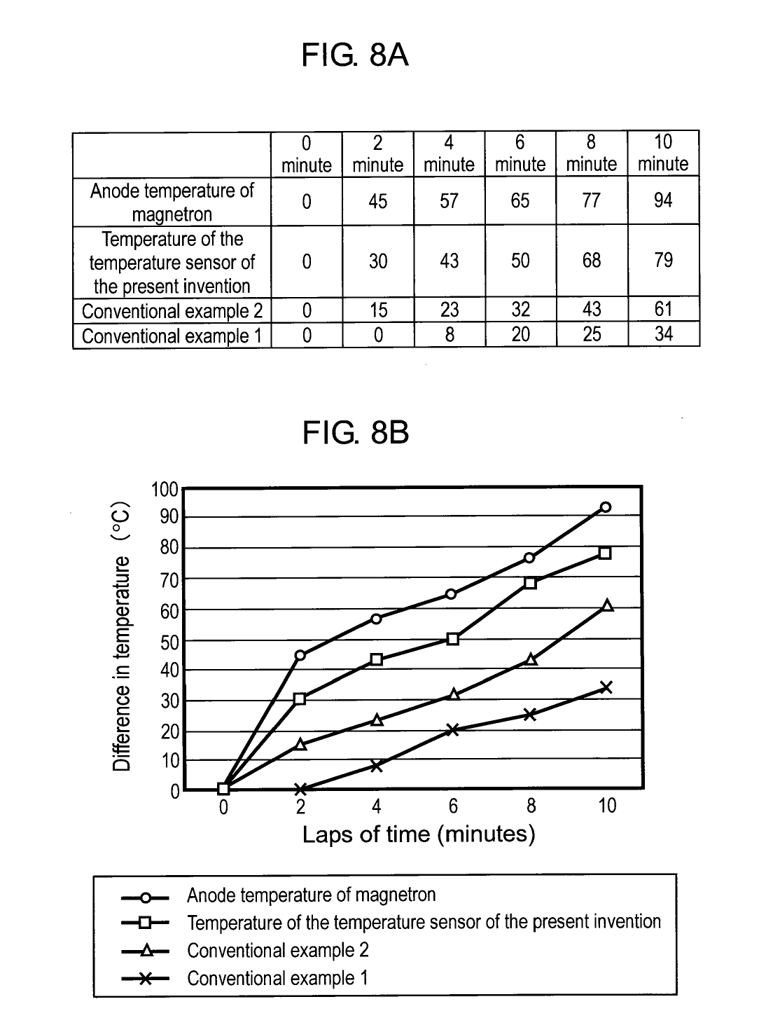

FIG. 1 is a perspective view of a high-frequency heating equipment in accordance with the first embodiment of the present invention. FIG. 2 and FIG. 3 are a plan view and a front view of an essential part, i.e. a structure of a magnetron, of the present. FIG. 4 and FIG. 5 are a plan view and a front view of a temperature sensor in accordance with the first embodiment. FIG. 6 shows variations in temperature during a no-load running in accordance with the first embodiment. FIG. 7 shows variations in temperature during a light-load (water 100 cc) running in accordance with the first embodiment. FIG. 8 shows differences in temperature between the no-load running and the light-load (water 100 cc) running in accordance with a first embodiment of the present invention.

In FIG. 1-FIG. 5, high-frequency heating equipment 17 in accordance with this first embodiment includes heating chamber 18 for accommodating object to be heated 5, magnetron 3 having multiple cooling fins 3B and radiating electromagnetic waves into heating chamber 18, power supply 19 for driving magnetron 3, and cooling fan 20 for cooling magnetron 3 and power supply 19. High-frequency heating equipment 17 further includes temperature sensor 21 for sensing a temperature of magnetron 3, mounting bracket 22 for holding temperature sensor 21, air guide 23 for guiding an airflow supplied from cooling fan 20, and controller 24 for controlling power supply 19, magnetron 3 and cooling fan 20. High-frequency heating equipment 17 in accordance with this first embodiment still further includes temperature sensor 21 is mounted with mounting bracket 22 such that temperature sensor 21 can be pressed by a lateral face of cooling fins 3B and an end of temperature sensor 21 points to anode 3A of magnetron 3 on the downwind side of cooling fan 20. As shown in FIG. 2 and FIG. 3, temperature sensor holding section 22A of mounting bracket 22 restricts airflow 25 (indicated with arrows) from cooling fan 20 toward temperature sensor 21

To be more specific, temperature sensor 21 is held by temperature sensor holding section 22A at approx. center (inside of the both ends at the sides of cooling fins 3B) of multiple cooling fins 3B. Lateral face 21A of temperature sensor 21 touches cooling fins 3B and is pressed by cooling fins 3B, and end 21B of temperature sensor 21 is held by mounting bracket 22 such that end 21B can be headed for anode 3A on the downwind side of cooling fan 20. Air guide 23 is often formed of resin material. Multiple cooling fins 3B are fixed at each of their both ends with yokes 3D.

In the case of no-load running, i.e. no object to be heated in heating chamber 18, the foregoing structure allows most of the electromagnetic waves radiated from magnetron 3 to reflect on chamber 18 and returns to magnetron 3, thereby raising the temperature of anode 3A of magnetron 3. The heat of anode 3A raises the temperature of temperature sensor 21 by means of radiation, conduction to cooling fins 3B, and convection to the ambient air. The temperature of temperature sensor 21 thus rises close to that of anode 3A.

When temperature sensor 21 senses a given threshold temperature, controller 24 halts the operation, thereby preventing magnetron 3 from falling in a thermal runaway which may result in breaking down magnetron 3.

Since temperature sensor 21 is excellent in the follow-up action, high-frequency heating equipment 17 can determine without fail whether the operation is a no-load running or a light-load running. High-frequency heating equipment 17 thus invites fewer malfunctions and expects stable performance, and the user can handle high-frequency heating equipment 17 with more ease and with safety.

The temperature variation characteristics in accordance with this first embodiment are shown in FIG. 6A-FIG. 8B. For instance, FIGS. 6A and 6B show variations in temperature and the graph thereof during the no-load running in accordance with the first embodiment. As shown in FIGS. 6A and 6B, the temperature of anode 3A of high-frequency heating equipment 17 rises to 271° C. in 10 minutes after the start of no-load running, i.e. no object to be heated 5 in heating chamber 18, and temperature sensor 21 senses a temperature of 247° C.

In the case of conventional example 1 disclosed in Patent Literature 1, the temperature sensor is mounted to outside cooling fin 3C, and the temperature sensor senses the temperature of 157° C. In the case of conventional example 2 disclosed in Patent Literature 2, the temperature sensor senses a temperature of 212° C. as the ambient temperature of magnetron 3. These comparisons prove that temperature sensor 21 in accordance with the first embodiment can sense the temperature close to that of anode 3A of magnetron 3, so that temperature sensor 21 can positively measure the anode temperature of magnetron 3.

FIGS. 7A and 7B show variations in temperature and the graph thereof during the light-load running in accordance with the first embodiment. In this instance, the temperature variation of water 100 cc in 10 minutes is measured. The anode temperature of magnetron 3 shows 177° C. in 10 minutes after the light-load running starts, and temperature sensor 21 senses 168° C. Conventional example 1 disclosed in Patent Literature 1 senses 123° C., while conventional example 2 disclosed in Patent Literature 2 senses 151° C. These comparisons prove that temperature sensor 21 in accordance with this first embodiment can sense the temperature close to the temperature of anode 3A of magnetron 3, so that it can be concluded that temperature sensor 21 can positively sense the anode temperature of magnetron 3.

FIGS. 8A and 8B show differences in temperature and the graph thereof between the no-load running and the light-load running. The temperature difference between the no-load running and the light-load running (water 100 cc) exhibits the following facts: in the case where anode 3A of magnetron 3 has a difference of (271-177)=94 degrees, temperature sensor 21 in accordance with this embodiment has a difference of (247-168)=79 degrees, and conventional example 1 disclosed in Patent Literature 1 has a difference of (157-123)=34 degrees, and conventional example 2 disclosed in Patent Literature 2 has a difference of (212-151)=61 degrees.

These comparisons prove that temperature sensor 21 can determine with ease whether the operation is a no-load running or a light-load running within the wider temperature range of 79 degrees, while the conventional examples are obliged to determine with difficulty within the smaller temperature range of 34 degrees or 61 degrees.

As discussed above, this first embodiment allows temperature sensor 21 to sense a temperature close to that of anode 3A of magnetron 3. The dispersion factors, such as the mounting state of temperature sensor 21, deformation of cooling fan 20, dispersion in the rpm of cooling fan 20, are thus excluded from causing temperature sensor 21 to delay sensing a temperature rise. As a result, high-frequency heating equipment 17 in accordance with this embodiment can prevent magnetron 3 from falling into a thermal runaway which may result in break down of magnetron 3, and can prevent the resin components, such as air guide 23, from melting down. On top of that, replacements of the broken down magnetron 3 or the melt-down resin components with new ones can be reduced, so that high-frequency heating equipment 17 is advantageous in view of resource saving.

### Exemplary Embodiment 2

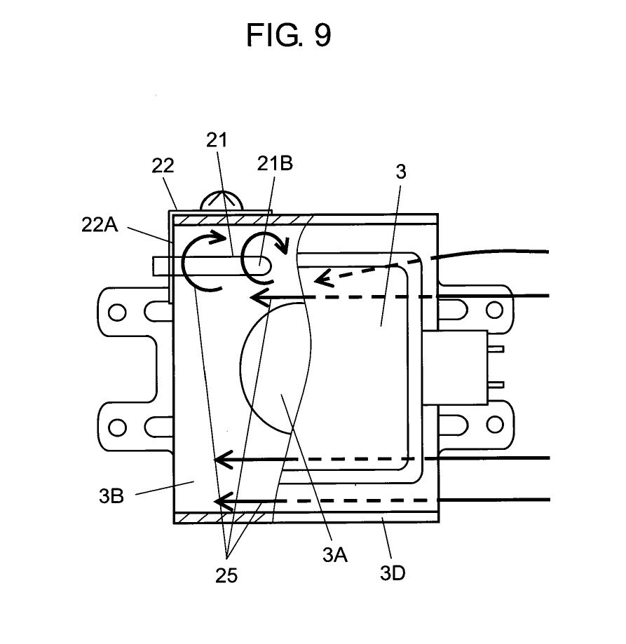

FIG. 9 is a lateral view cutaway in part of a mounting bracket in accordance with the second embodiment of the present invention (FIG. 9 is a profile viewed from the right side of FIG. 3). As shown in FIG. 9, mounting bracket 22 restricts airflow 25 from cooling fan 20 to temperature sensor 21 (refer to arrows). To be more specific, mounting bracket 22 shuts off airflow 25 so that temperature sensor 21 cannot be cooled by cooling fan 20.

The foregoing structure allows holding section 22A of mounting bracket 22 to shut off the airflow blown from cooling fan 20 to temperature sensor 21 which shows a temperature rise due to the heat from anode 3A of magnetron 3. Airflow 25 around temperature sensor 21 thus stagnates as arrows indicate, so that airflow 25 less cools temperature sensor 21.

Temperature sensor 21 senses the temperature rise caused by the heat from anode 3A of magnetron 3; however, the airflow supplied from cooling fan 20 suppresses this temperature rise. The structure discussed above allows suppressing the temperature rise, thereby preventing temperature sensor 21 to delay sensing the given temperature. As a result, the risk of breaking down magnetron 3 or the risk of melting down the resin components, e.g. air guide 23, can be reduced.

Replacements of the broken magnetron 3 or melted air-guide 23 with new ones can be thus reduced, so that high-frequency heating equipment 17 is advantageous in view of resource saving.

### Exemplary Embodiment 3

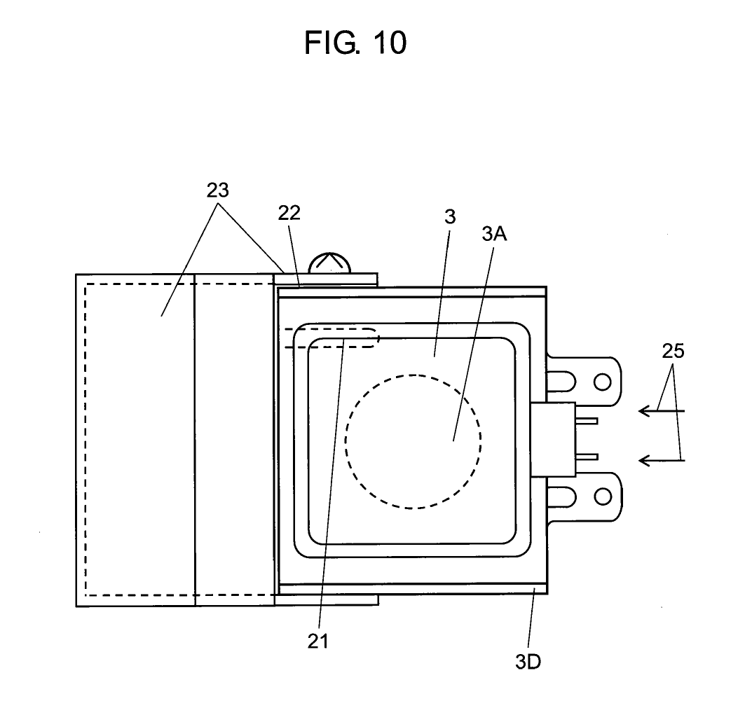

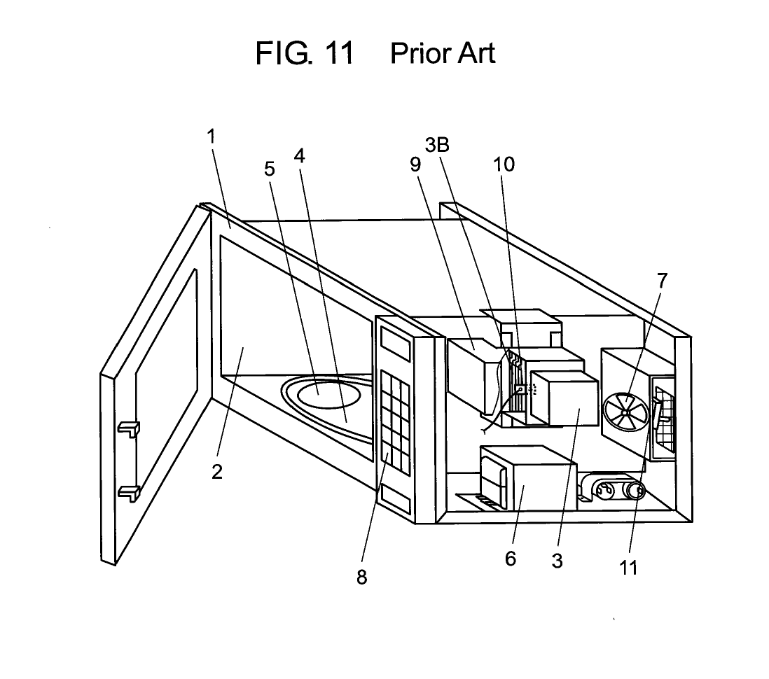

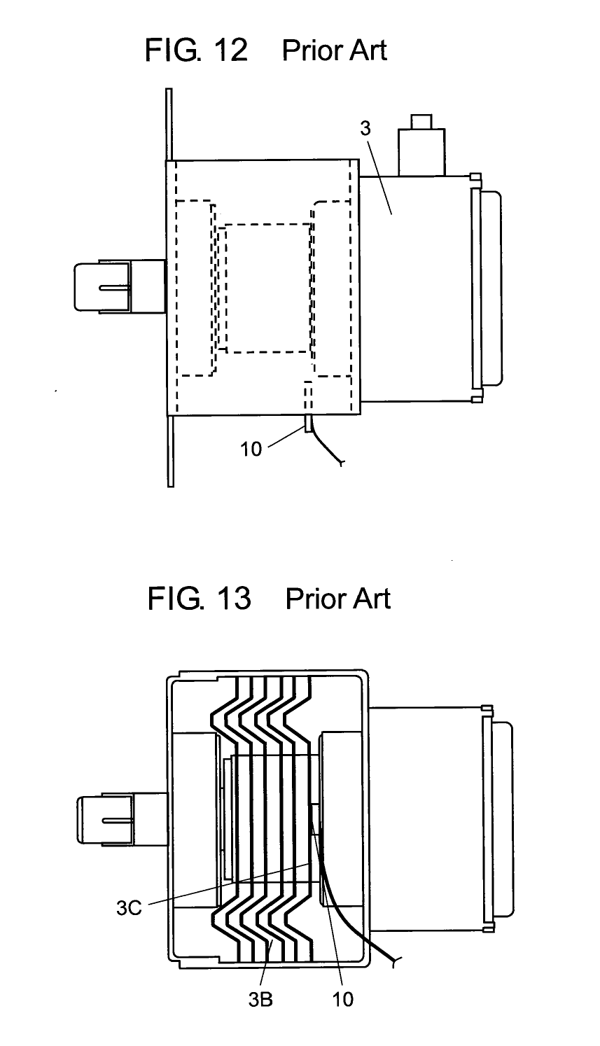

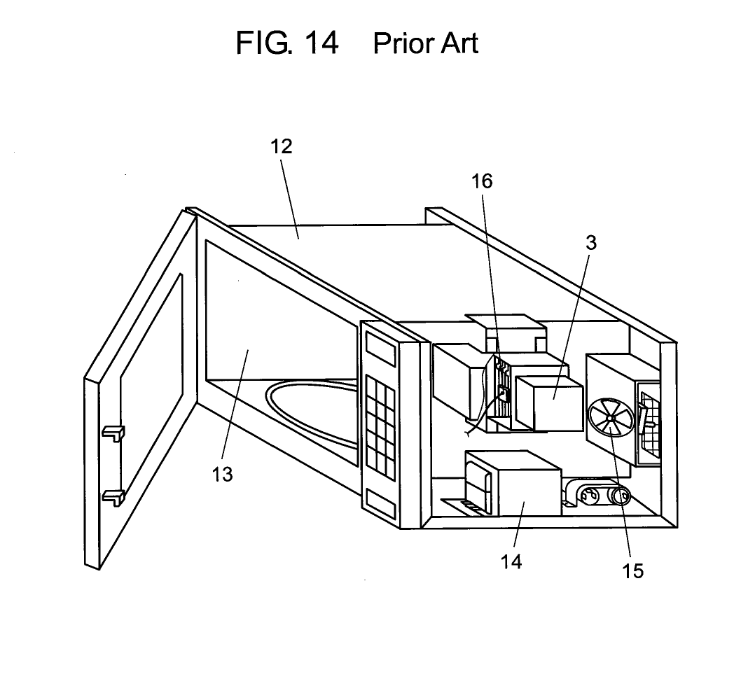

FIG. 10 is a lateral view illustrating a structure in accordance with the third embodiment. As shown in FIG. 10, mounting bracket 22 for holding temperature sensor 21 is clamped between yokes 3D of magnetron 3 and air guide 23 placed on downwind side of airflow 25 supplied from cooling fan 20.

The foregoing structure allows airflow 25 supplied from cooling fan 20 to less affect mounting bracket 22 because mounting bracket 22 is covered by air guide 23, so that mounting bracket 22 can prevent the temperature of temperature sensor 21 from lowering. The third embodiment thus can prevent temperature sensor 21 from the delay of sensing the given temperature, thereby reducing the risk of breaking down magnetron 3 or the risk of melting down the resin components, e.g. air guide 23. On top of that, replacements of broken magnet 3 or melted air guide 23 with new ones can be reduced. The high-frequency heating equipment in accordance with the third embodiment is thus advantageous in view of resource saving.

As discussed previously, the high-frequency heating equipment of the present invention comprises the following structural elements:
a heating chamber for accommodating an object to be heated;
a magnetron including multiple cooling fins and radiating electromagnetic waves into the heating chamber;
a power supply for driving the magnetron;
a cooling fan for cooling the magnetron and the power supply;
a temperature sensor for sensing a temperature of the magnetron;
a mounting bracket holding the temperature sensor;
an air guide for guiding an airflow supplied by the cooling fan; and
a controller for controlling the power supply, the magnetron, and the cooling fan.

The temperature sensor is mounted with the mounting bracket such that the temperature sensor is pressed by a lateral face of the cooling fins, and an end of the temperature sensor points to an anode of the magnetron on the downwind side of the cooling fan.

The foregoing structure allows mounting the temperature sensor such that the cooling fins can press the temperature sensor on the lateral face and the end of the temperature sensor points to the anode of the magnetron on the downwind side of the cooling fan. In the case of a no-load running, i.e. no object to be heated in the heating chamber, most of the electromagnetic waves radiated from the magnetron reflect on the heating chamber and returns to the magnetron, thereby raising the temperature of the anode of the magnetron. The heat of the magnetron raises the temperature of the temperature sensor by means of radiation, conduction to the cooling fins, and convection to the ambient air, so that the temperature sensor senses a temperature close to that of the anode of the magnetron. This mechanism allows the temperature sensor to sense a given threshold temperature for the controller to perform control operation, e.g. halting the operation of the high-frequency heating equipment. The magnetron thus can be prevented without fail from falling into a thermal runaway which may result in a breakdown of the magnetron.

The temperature sensor is excellent in follow-up action, and it can determine without fail whether the operation is a no-load running or a light-load running, so that the high-frequency heating equipment with stable quality and fewer malfunctions is obtainable. The users thus can use this high-frequency heating equipment with ease.

The temperature sensor can sense a temperature close to the anode temperature of the magnetron. Therefore, dispersing factors, e.g. a mounting state of the mounting bracket, deformation of the cooling fan, and dispersion in the rpm of the cooling fan, are excluded from causing the temperature sensor to delay sensing a temperature rise. As a result, a risk of thermal runaway which may break down the magnetron as well as a risk of melt-down of the resin components, e.g. the air guide near the magnetron, can be reduced. Replacements of the broken-down magnetron or melt-down components with new ones can be thus reduced, so that the high-frequency heating equipment of the present invention is advantageous in view of resource saving.

The present invention includes the mounting bracket that provides a structure of restricting the airflow from the cooling fan to the temperature sensor. This structure allows mitigating the suppression of the temperature rise of the temperature sensor. Because the heat from the anode of the magnetron anode raises the temperature of the temperature sensor; however, the airflow from the cooling fan suppresses this temperature rise, and this suppression causes the temperature sensor to delay sensing the threshold temperature. As a result, the mitigation of the suppression prevents the magnetron from falling into a breakdown or the resin components from melting down. The replacements of the broken magnetron or the melted components with new ones can be reduced, so that the high-frequency heating equipment is advantageous in view of resource saving.

The mounting bracket of the present invention is clamped between the yoke of the magnetron and the air guide disposed on the downwind side of the cooling fan. This structure allows the mounting bracket to be covered with the air guide, so that the cooling air supplied from the cooling fan less affects the temperature sensor, and the mounting bracket suppresses the reduction in temperature of the temperature sensor. This mechanism prevents the temperature sensor from delaying a sense of the threshold temperature, so that a risk of breaking down the magnetron or melting down the resin components can be reduced.

The mounting bracket of the present invention is mounted inside of both the ends at one side of the cooling fins. This structure allows the temperature sensor to be placed near the center of the cooling fins, so that the temperature sensor can sense a temperature close to the anode temperature of the magnetron in a faster and a more reliable manner. The no-load running or the light-load running can be thus determined in a more reliable manner, so that stable performance and fewer malfunctions can be expected. The magnetron can be prevented more positively from falling into the thermal runaway which may result in a breakdown of the magnetron.

### INDUSTRIAL APPLICABILITY

A high-frequency heating equipment of the present invention is excellent in follow-up action, so that it can determine whether the operation is no-load running or a light-load running in a reliable manner. The high-frequency heating equipment with stable performance and fewer malfunctions is thus obtainable. The high-frequency heating equipment can prevent without fail the magnetron from falling into a thermal runaway that invites a breakdown of the magnetron. The high-frequency heating equipment is thus useful not only for home use but also for various applications including professional use.

### DESCRIPTION OF REFERENCE SIGNS

3 magnetron

3A anode

3B cooling fin

3D yoke

5 object to be heated

17 high-frequency heating equipment

18 heating chamber

19 power supply

20 cooling fan

21 temperature sensor

21A lateral face

21B end

22 mounting bracket

22A holding section

23 air guide

24 controller

25 airflow

1. A high-frequency heating equipment comprising:
a heating chamber for accommodating an object to be heated;
a magnetron including a plurality of cooling fins and radiating an electromagnetic wave into the heating chamber;
a power supply for driving the magnetron;
a cooling fan for cooling the magnetron and the power supply;
a temperature sensor for sensing a temperature of the magnetron;
a mounting bracket holding the temperature sensor;
an air guide for guiding an airflow supplied by the cooling fan; and
a controller for controlling the power supply, the magnetron, and the cooling fan,
wherein the temperature sensor is mounted with the mounting bracket such that the temperature sensor is pressed by a lateral face of the cooling fins and an end of the temperature sensor points to an anode of the magnetron on the downwind side of the cooling fan.

2. The high-frequency heating equipment of claim 1, wherein the mounting bracket restricts the airflow from the cooling fan to the temperature sensor.

3. The high-frequency heating equipment of claim 1, wherein the mounting bracket is clamped between a yoke of the magnetron and the air guide disposed on the downwind side of the cooling fan.

4. The high-frequency heating equipment of claim 1, wherein the mounting bracket is mounted inside of both ends at one side of the cooling fins.
